(19) United States
(12) Patent Application Publication
(10) Pub. No.: US 2009/0311394 A1
(43) Pub. Date: Dec. 17, 2009

(54) ANTIMICROBIAL MICELLES FOR FOOD APPLICATIONS

(75) Inventors: Gunter Kirchner, Bietigheim-biss (DE); Derrick Bautista, Rielasingen-worblingen (DE); Kathrin Benz, Radolfzell (DE); Guillermo Eduardo Napolitano, Wallhausen - Konstanz (DE)

Correspondence Address: K&L Gates LLP, P.O. Box 1135, CHICAGO, IL, 60690, US

(73) Assignee: NESTEC S.A., Vevey (CH)

(21) Appl. No.: 12/375,818

(22) PCT Filed: Jul. 20, 2007
(86) PCT No.: PCT/EP07/57526

§ 371 Date: Jan. 30, 2009

(30) Foreign Application Priority Data
Aug. 9, 2006 (EP) 06016639.4

(51) Int. Cl. A23L 3/3472; A23L 3/3463

(52) U.S. Cl. 426/330.1; 426/532; 426/335; 426/334; 426/330.6; 426/332; 426/330

(57) ABSTRACT

The present invention relates to methods for improving the microbiological safety and stability of foods by the use of food-grade micelles that encapsulate antimicrobial agents. The invention also relates to the food compositions thus obtained.

### FIELD OF THE INVENTION

The present invention relates to methods for improving the microbiological safety and stability of foods by the use of food-grade micelles that encapsulate antimicrobial agents. The invention also relates to the food compositions thus obtained.

### BACKGROUND OF THE INVENTION

Microbial contamination of food can be a considerable health risk. It may lead to heavy gastrointestinal disorders and is also the suspected cause of “summer-influenza” which is associated with sickness, emesis, diarrhoea and ague. Harmful microorganisms may also contain or excrete strong poisons which may lead to perilous contamination, for example meat poisoning causing botulism. In certain cases, the microorganism can also be carcinogenic (e.g. from mycotoxins of special moulds).

Food spoilage or food poisoning is usually prevented by a combination of different hurdles (e.g. heating, reduced water activity, chilled distribution, presence of preservatives) which inhibit or completely destroy bacteria, yeast and moulds.

However, preservatives which are legally approved and commonly used may still be harmful to some consumers. For instance, benzoic acid and sorbic acid may cause allergies, while sulphite, sulphurous acid, and sulphur dioxide may have further deleterious effects. The preservatives used in cured meat products may also release carcinogenic compounds when heated over 12° C.

There is thus a tendency to look for harmless alternatives which can be used in food products. Amongst these, spices and/or extracts from various plants or fruits have proven to be effective antimicrobial agents. For instance, Weiss J. et al. in Journal of Food Protection, Vol. 68, No. 12, 2005, p. 2559-2566 and in Journal of Food Protection, vol. 68, No. 7, 2005, p. 1359-1366 describe the antimicrobial effect of essential oil components.

The problem with including these in food products, however, is that the taste of the food product may be altered, or that solubility and thus stability/efficiency issues may arise.

### OBJECT OF THE INVENTION

There thus remains a need to provide an improved way in which to make food compositions more resistant to harmful microorganisms.

### SUMMARY OF THE INVENTION

Accordingly, the present invention provides, in a first aspect, a food composition comprising nutritional ingredients and micelles incorporating at least one antimicrobial agent.

A second aspect of the invention relates to a method for improving the microbiological safety and stability of food comprising the steps of:
a. Preparing an emulsion comprising food-grade surfactant micelles incorporating at least one antimicrobial agent, and
b. Incorporating said emulsion into a food composition.

The use of an emulsion comprising food-grade surfactant micelles incorporating at least one antimicrobial agent in the manufacture, storage or preparation of a food composition is also part of the present invention.

According to another aspect of the invention, a method for improving the microbiological safety and stability of food comprising the steps of
a. preparing an emulsion comprising food-grade surfactant micelles incorporating at least one antimicrobial agent in order to improve the sensorial perception of said antimicrobial agent, and
b. incorporating said emulsion into a food composition
   is provided.

A dried antimicrobial product comprising a food-grade surfactant and an antimicrobial agent which, upon hydration, has the capability of generating an emulsion of micelles incorporating said antimicrobial agent and the use of said dried products constitute further aspects of the present invention.

### FIGURES

The present invention is described hereinafter with reference to some embodiments shown in the figures wherein

FIG. 1 shows a simplified view of a surfactant micelle in water,

FIG. 2 compares the growth of E. coli DSM 6367 in a grill sauce (“Chakalaka” sauce) with and without the micelles incorporating an antimicrobial agent,

FIG. 3 compares the growth of E. coli DSM 6367 in a marinade with and without the micelles incorporating an antimicrobial agent,

FIG. 4 shows the in vitro growth inhibition of Lactobacillus buchneri by two types of surfactant micelles without and with an antimicrobial agent, and

FIG. 5 shows the in vitro growth inhibition of E. coli by two types of surfactant micelles without and with an antimicrobial agent.

FIG. 6 shows the in vitro growth inhibition of Salmonella of clove, oregano and mustard oil encapsulated in micelles.

FIG. 7 shows the in vitro growth inhibition of Staphylococcus aureus, Listeria spp., E. coli of clove oil encapsulated in micelles.

FIG. 8 shows the in vitro growth inhibition of Staphylococcus aureus, Listeria spp., E. coli of oregano oil encapsulated in micelles.

FIG. 9 shows the growth inhibition of various moulds and yeasts in a food paste (chilli/coriander) with mustard oil encapsulated in micelles.

FIG. 10 shows the growth inhibition of mustard oil encapsulated in micelles in lemongrass/ginger and chilli/coriander food paste

FIG. 11 shows the Salmonella spp. count of chicken samples submerged in a marinade comprising oregano oil encapsulated in micelles at varying concentrations after 30 minutes.

### DETAILED DESCRIPTION OF THE INVENTION

In order to create food compositions which are resistant to harmful microorganisms, the present invention proposes a food composition which comprises nutritional ingredients and food-grade surfactant micelles.

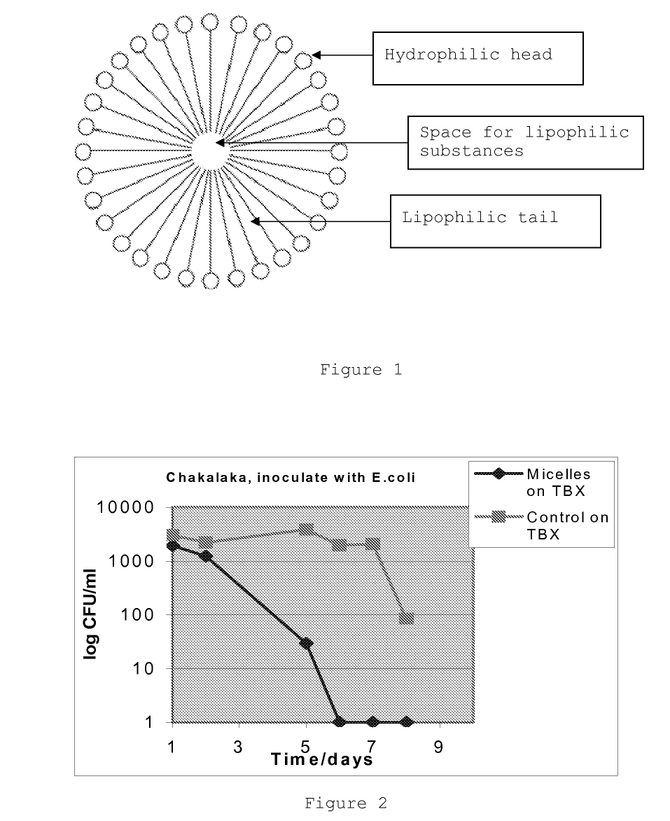

Micelles are depicted in FIG. 1. They consist of an assembly of surfactant molecules supramolecularly arranged so as to form a spherical structure with a lipophilic core and a hydrophilic surface.

The surfactants used to produce the micelles are food-grade surfactants that may be selected from the surfactant class of polyoxyethylene sorbitan monooleate (Admul T 80 K) or may be selected from animal or plant sources that have active emulsifying properties. According to the present invention, the lipophilic core comprises an antimicrobial agent such that the antimicrobial agent is encapsulated in the micelle.

The antimicrobial agent may be selected from essential oils extracts. Essential oils include clove oil, bay oil, cinnamon oil, oregano oil, thyme oil, caraway oil, dill oil, coriander oil, citrus oil, orange oil etc. In one embodiment, the antimicrobial agent is selected from eugenol, limonene, carvacrol and any mixtures thereof. It may also be selected from other essential oils.

In a preferred embodiment, the antimicrobial agent is selected from clove oil, bay oil, cinnamon oil, oregano oil, thyme oil, caraway oil, dill oil, coriander oil, citrus oil, orange oil, mustard oil or any combinations thereof. Most preferably, the antimicrobial agent is clove oil, oregano oil, mustard oil or any combination thereof.

Due to their low or non-solubility in water, these compounds are favourably incorporated in the lipophilic core of the micelles.

The surfactant micelles present in the food composition of the invention may thus comprise at least one antimicrobial agent.

Thus, the antimicrobial agent is present in the food composition of the invention in a concentration between 0.05-1.5% by weight of the composition.

The food composition of the invention also comprises nutritional ingredients which may be selected from carbohydrates, fats, proteins, fibres, minerals, vitamins and any mixtures thereof.

The food composition may be water, in particular flavoured bottled waters, sauces, marinades, mayonnaises, mustards, ketchups, salad creams, salad dressings, soups, canned fruits, milk products, meats, fish, vegetables etc. It may be zero-fat, low-fat or medium fat up to a fat content of 50%.

By flavoured bottled water is meant any mineral water containing some natural or artificial flavouring e.g. mint, lemon, orange etc. The water may also contain a source of sugars.

The pH of the food composition may vary between 2 and 8, and is preferably between 3 and 7, most preferably between 5 and 7. This constitutes an advantage over products wherein a low pH is required in order to ensure microbiological safety.

In an embodiment, the food composition comprises no salt. In a further embodiment, the water activity of the food composition is more than 0.5, preferably more than 0.7, even more preferably more than 0.8.

Preferably, the compositions of the invention are free of additives. By additives is meant any preservative, E-number etc. which is added for conservation/stability purposes. Thus, the present invention provides for food compositions with clean labels.

Furthermore, the presence of the micelles allow the product to be stored at room temperature and to be shelf-stable without compromising the microbiological safety. Traditional methods for insuring microbiological safety such as lowering the pH of the product, increasing the salt content, refrigerating the product etc. may be no longer necessary.

Antimicrobial agents such as those described above may have a strong, noticeable taste, which may not always be compatible with the food composition they may be added to. A further advantage of the present invention is that by encapsulating the antimicrobial agent in a micellar structure, the sensorial perception of said antimicrobial agent is reduced. Thus, an increased amount of antimicrobial agent may be used without compromising the organoleptic properties of the food composition. This results in food compositions which are highly resistant to microbiological contamination while remaining highly palatable.

The food composition of the invention is microbiologically safe against pathogenic bacteria, yeasts and moulds. By “microbiologically safe” is meant that no growth of pathogenic microorganisms can be observed for the intended shelf-life of the product. The food composition is also stable to microbiological spoilage, meaning that no growth of spoilage microorganisms (bacteria, yeast, moulds) can be observed for the intended shelf-life of the product.

It is also shelf-stable as it does not deteriorate at room temperature over a period of at least 6 months, preferably at least 1 year.

It is also stable under refrigeration temperatures as it does not deteriorate over a period of at least 1 month, preferably at least 2 months.

Thus the invention provides a method for improving the microbiological safety and stability of foods. The method comprises in a first step, the preparation of an emulsion comprising food-grade surfactant micelles incorporating at least one antimicrobial agent.

The emulsion is prepared by mixing a food-grade surfactant in an aqueous medium in order to form micelles, and then adding the antimicrobial agent to the micelle emulsion.

Preferably, the antimicrobial agent is added with stirring over a period of time, usually about 10-15 minutes.

Preferably the antimicrobial agent is selected from clove oil, bay oil, cinnamon oil, oregano oil, thyme oil, caraway oil, dill oil, coriander oil, citrus oil, orange oil, mustard oil or any combinations thereof. More preferably, it is clove oil, oregano oil, mustard oil or any combination thereof.

The amount of antimicrobial substance to be added may be easily determined by turbidity measurements. Indeed, the antimicrobial agent is dispersed in water by being encapsulated in the micelle. When turbidity appears in the aqueous solution, it is an indication that the antimicrobial agent, which is poorly or non-soluble in water, is no longer being incorporated in the micelles.

Typically, the concentration of antimicrobial agent in the aqueous medium is at least 0.1%, preferably up to 3%.

The emulsion thus prepared is then incorporated into a food composition. Preferably, it is incorporated in an amount up to 80% by weight of the food composition.

The food composition may be water, in particular flavoured bottled waters, sauces, marinades, mayonnaises, mustards, ketchups, salad creams, salad dressings, soups, canned fruits, milk products, meats, fish, vegetables etc. Typically, the food composition is one sensitive to moulds, yeasts and/or bacteria

The use of an emulsion comprising food-grade surfactant micelles incorporating at least one antimicrobial agent in the manufacture, storage or preparation of a food composition is also part of the present invention.

Thus, the emulsion may be used at the manufacturing stage in the factories, in restaurants for the preparation of foods, or even at home by the consumer. The use of said emulsion thus improves the microbiological safety and stability of said food composition.

The emulsion may be stored under ambient, chilled or frozen conditions.

In particular, the emulsion which comprises food-grade surfactant micelles incorporating at least one antimicrobial agent may be used for inhibiting the activity of bacteria, moulds, and yeasts such as Escherichia spp., Staphylococcus spp., Bacillus spp., Listeria spp., Lactobacillus spp., Salmonella spp., Penicillium spp., Saccharomyces spp., Debaryomyces spp., Pichia spp., Mucor spp., Eurotium spp.

More specifically, it is used for inhibiting the activity of Escherichia coli, Staphylococcus aureus, Bacillus cereus, Listeria monocytogenes, Lactobacillus buchneri, Salmonella enterica, Penicillium chrysogenum, Saccharomyces cerevisiae, Debaryomyces hansenii, Pichia farinosa, Mucor plumbeus.

In a preferred embodiment, the emulsion comprises food-grade surfactant micelles incorporating oregano oil. This emulsion is particularly useful for the complete inhibition of Salmonella spp. Indeed, it is very effective for treating Salmonella sensitive food, as all the Salmonella is inhibited within 5 minutes of the emulsion coming into contact with said Salmonella. Such emulsion may find application, for example, as a marinade sauce for chicken, for microwave cooking applications etc.

In another embodiment, the emulsion comprises food-grade surfactant micelles incorporating mustard oil. This emulsion is particularly useful in food products which are sensitive to mould contamination. These are usually sauces which are designed to have a long shelf-life.

In another embodiment of the invention, a method for improving the microbiological safety and stability of food is provided comprising the step of preparing an emulsion comprising food-grade surfactant micelle incorporating at least one antimicrobial agent in order to improve or reduce the sensorial perception of said antimicrobial agent and then incorporating said emulsion into a food composition.

The present invention also encompasses a dried antimicrobial product comprising a food-grade surfactant and an antimicrobial agent. The food-grade surfactant may be selected from the surfactant class of polyoxyethylene sorbitan monooleate (Admul T 80 K) or may be selected from animal or plant sources that have active emulsifying properties. The antimicrobial agent may be selected from eugenol, limonene, carvacrol and/or other essential oils. Preferably the antimicrobial agent is selected from clove oil, bay oil, cinnamon oil, oregano oil, thyme oil, caraway oil, dill oil, coriander oil, citrus oil, orange oil, mustard oil or any combinations thereof. More preferably, it is clove oil, oregano oil, mustard oil or any combination thereof.

The dried product is such that upon hydration, an emulsion of micelles incorporating said antimicrobial agent is generated. It therefore acts as a precursor to the antimicrobial micelle emulsions described above.

It may be stored under ambient, chilled or frozen conditions and may be used in dried food compositions such as package soup, milk powders, drink powders etc.

As a summary, the present invention provides the advantages that the microbiological safety and stability of food is achieved while maintaining the palatability of said food. The need for pasteurisation or higher thermal processing for food products can be reduced or eliminated. The invention also offers the advantage that higher pH values and reduction of the acid, salt, sugar or preservative content may be achieved in food products without compromising microbiological safety. The invention also allows to increase the shelf-life stability of food products. Moreover, it allows to reduce the risk of microbiological recontaminations of foods. Finally, micelles that have encapsulated antimicrobial agents are easily generated and can replace undesirable preservatives, “E-numbers” etc. such that clean labelling may be achieved.

The present invention is further illustrated by non-limiting examples.

### EXAMPLES

### Example 1a

### In Vitro Testing

Used culture media:
M.R.S.-Bouillon, Merck, 1.10661
Brilliant Green Bile 2% (Broth), Oxoid, CM0031
Peptone from casein pancreatically digested, Merck, 1.07213
D(+)-Glucose, Merck, 1.08337

Used agars:
M.R.S. Agar, Oxoid, CM 0316
Tryptone Bile X-glucuronide Agar, Merck, 1.16122

Used emulsifiers:
Surfynol 495W, Air Products Nederland BV, S-485W
Admul T 80 K, Kerry Bio-Science, 5Z10754

Used essential oil components:
Eugenol, Fluka, 41600
Carvacrol, Fluka, 22051
R(+)-Limonene, Fluka, 62119

Used microorganisms:
Lactobacillus buchneri DSM 20174 418*/#
E. coli SLV 082 504*

All emulsions were prepared with distilled and deionised water.

The “empty” micelles were produced by mixing the emulsifier with water.

The aim was to encapsulate in these micelles the main components of essential oils with antimicrobial effects.

These components were eugenol, R-Limonene and carvacrol, which can be found for example in clove oil, orange oil and thyme oil.

The turbidity of the solution was used as visual control: How homogenous and colourless the solution was after production and storage overnight determined how successful the encapsulation of the substances in the micelles was. Best results were reached with a clear and homogenous water-oil emulsion.

Concentrations under 0.1% essential oil components showed no satisfactory antimicrobial effect, while much higher concentration of the essential oil components (up to 3%) provided increased antimicrobial effect.

For producing the micelles it was necessary to test different water/emulsifier/antimicrobial concentrations to evaluate the best combination for the encapsulation.

A minimal medium consisting of a peptone-glucose solution mixed with the micelles was used as culture medium. The concentrations (all concentrations are in weight percent, w/w) were as follows:
0.1% peptone
1.0% glucose
1.0% Eugenol
5.0% emulsifier (both emulsifiers were tested)
92.9% water

As negative-control a solution of water, peptone and glucose was used.

The antimicrobial effects were tested on two bacteria (E. coli and Lactobacillus) and one encapsulated antimicrobial (eugenol) was tested.

Each test was preformed in triplicate.

After initial weighing and mixing of the substances the pH was adjusted. The pH was 4.5 for Lactobacillus and 5.0 for E. coli. Before inoculation the samples were filtrated (0.20 μm) under sterile conditions.

The initial cell count in the samples was 10⁴ CFU/ml. The samples were incubated over 7 to 12 days at 25° C. and a daily bacterial count was done.

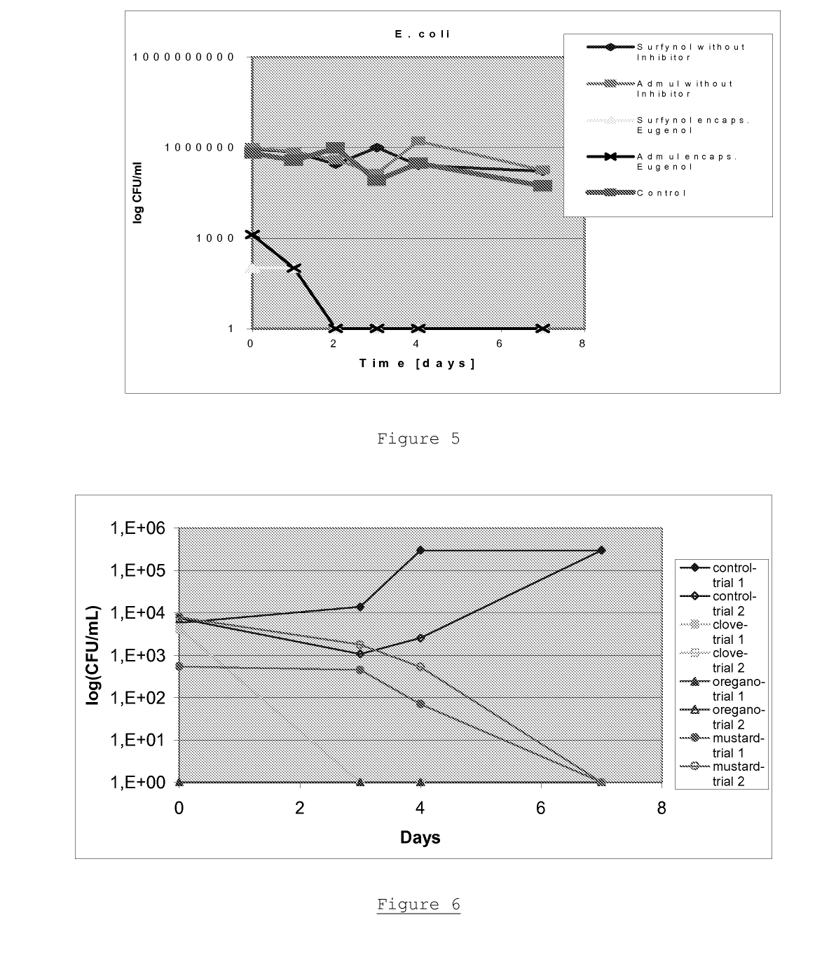

In both trials a clear inhibition with eugenol-containing micelles on Lactobacillus buchneri and E. coli was demonstrated (cf. FIGS. 4 and 5)

### Example 1b-1d

The same in vitro conditions as described above were used to test the antimicrobial properties of micelle encapsulated essential oils, notably clove oil, oregano oil and mustard oil.

### Example 1b

As can be seen on FIG. 6, Salmonella spp. was inactivated by all three essential oils. Oregano oil shows the strongest inactivation since it is able to kill Salmonella spp. rapidly within approximately five minutes after inoculation.

### Example 1c

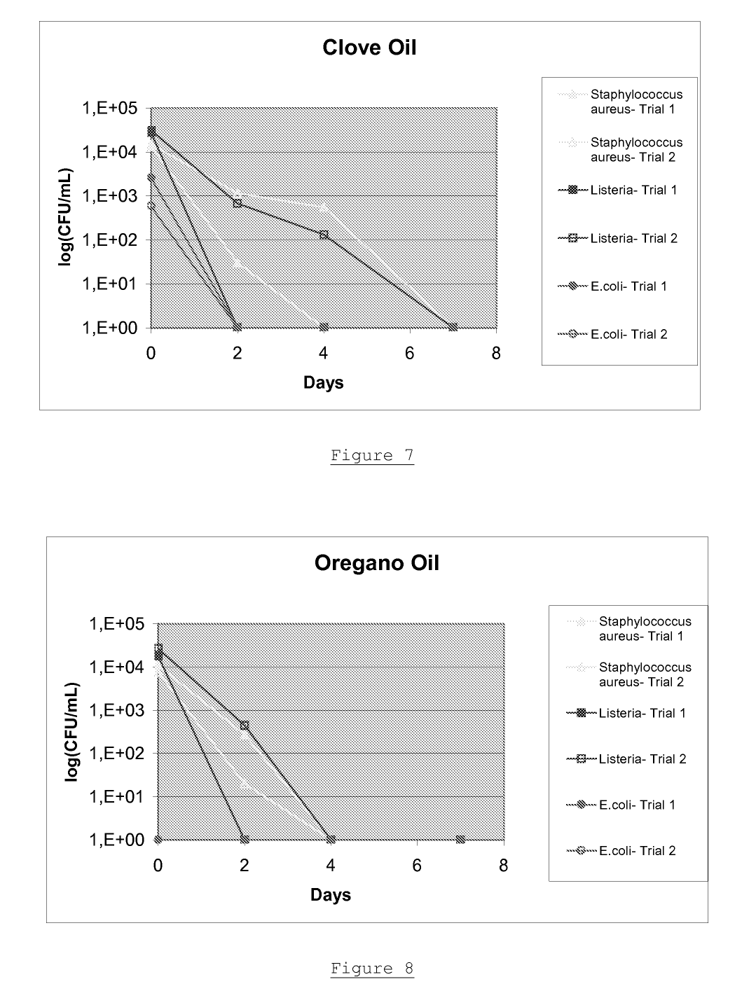

As can be seen in FIG. 7, micelle encapsulated clove oil was effective against the growth of Staphylococcus, Listeria and E. coli microorganisms.

### Example 1d

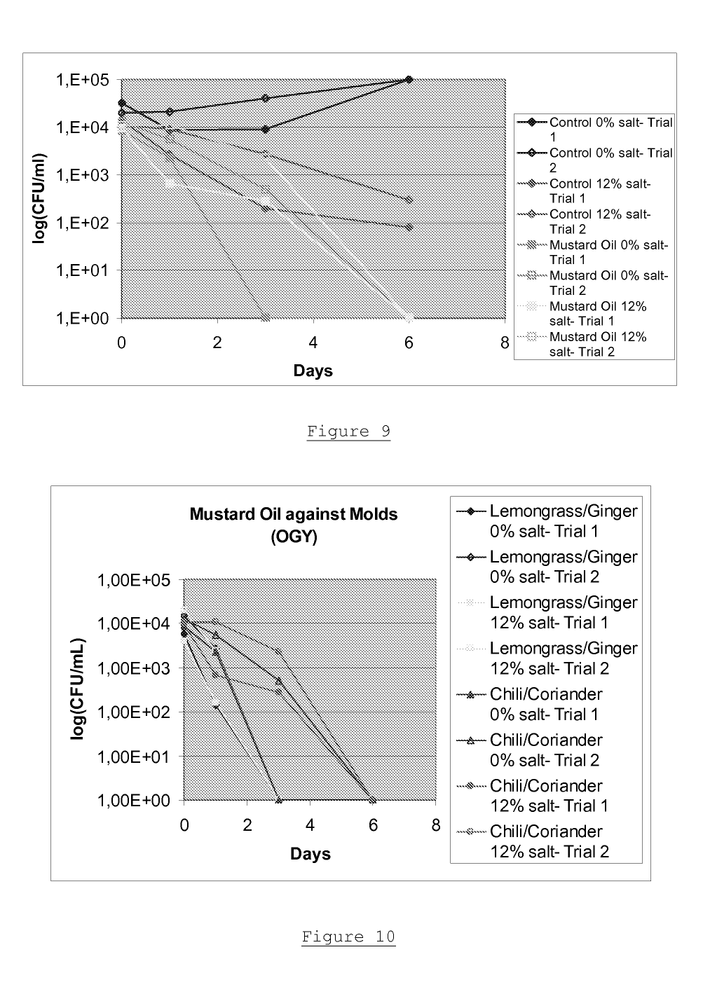

FIG. 8 shows the effect of oregano oil, encapsulated in micelles against the growth of Staphylococcus, Listeria and E. coli microorganisms.

### Example 2

### In situ Testing

Used products:
Maggi® Chakalaka sauce
Fat-free Marinade containing fruit juices, garlic, ginger and honey.

Used agar:
Standard plate count agar (PCA) ready-to-use-petri dishes
M.R.S. Agar, Oxoid, CM 0316
Tryptone Bile X-glucuronide Agar, Merck, 1.16122

Used emulsifiers:
Admul T 80 K, Kerry Bio-Science, 5Z10754

Used essential oil components:
Eugenol, Fluka, 41600

Used microorganism:
E. coli DSM 6367

All solutions were prepared with distilled and deionised water.

The aim of this experiment was a prolongation of the shelf-life in two different products or an elevation of the pH of the products by adding eugenol containing micelles.

The selected food products were a fat-free marinade and a grill sauce with a low fat content of 3% (Chakalaka).

The maximal eugenol concentration which was encapsulated in 5% emulsifier was 1% eugenol.

At the start of the experiment, the two products are mixed with the micelle emulsion according to the previously determined concentrations (w/w), filled in glasses and adjusted to the desired pH value.

The concentrations were as follows:
Chakalaka: 40% micelle emulsion and 60% Chakalaka sauce
Marinade: 60% micelle emulsion and 40% Marinade

The eugenol concentration per 100 g Chakalaka sauce was 0.4%, and 0.66% eugenol per 100 g marinade.

The pH of the samples to be inoculated with E. coli was 5.0. Four different samples were produced, which were later inoculated.

During inoculation with the bacteria E. coli DSM 6367, as well as during preparation of the samples, sterile conditions were used.

The samples were incubated at 20° C. for one week.

The bacterial growth was checked daily by bacterial count to confirm the inhibitory effects of the micelles.

The cell count determination was also done on PCA ready-to-use Petri dishes at the beginning and at the end of the trial to get an overview of the existing bacterial flora in the product.

By repetition of the experiments, the results of the first trial could be reproduced and the inhibitory effects of the micelles satisfactorily demonstrated.

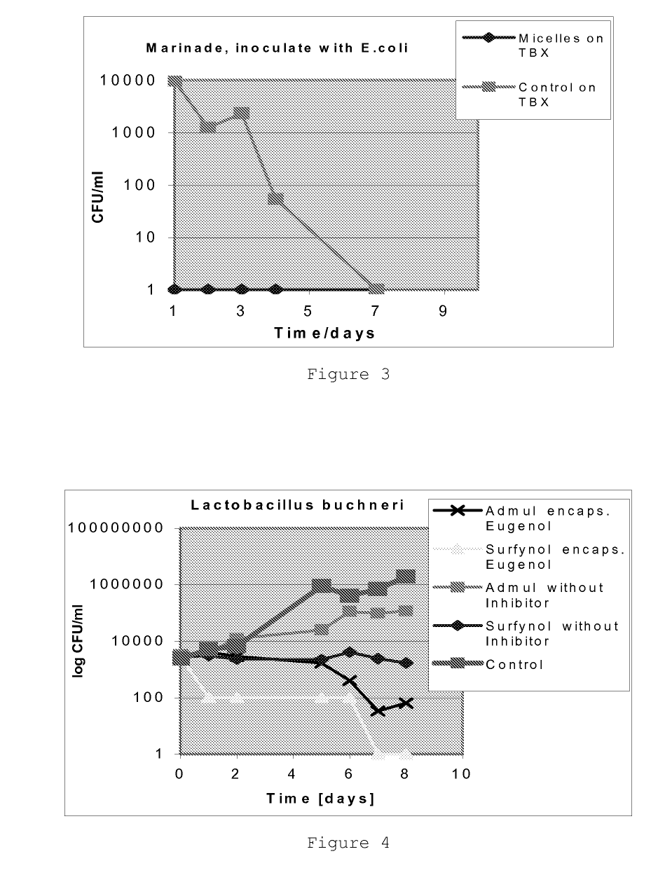

In both trials (FIGS. 2 and 3), a clear growth inhibition by the micelles was demonstrated.

### Example 3

A cocktail of yeasts and moulds was prepared. These were Saccharomyces cerevisiae 208, Debaromyces hansenii 233, Pichia farinosa 200, Mucor plumbeus #728, Penicillium chrysogenum #722, Eurotium spp. #700. These were inoculated in precultures.

The micelles were prepared separately by mixing 10% Admul T80K with 88% distilled water. Mustard oil (2%) was slowly added to the solution until completely suspended in the solution.

A chilli/coriander or lemongrass/ginger food paste (75%) at varying salt levels (0% salt and 12% salt) was mixed with the aqueous solution (25%) giving a final overall composition comprising 0.5% mustard oil and 2.5% Admul T80K.

The pH of the paste could be adjusted and was then inoculated with the cocktail of yeasts and moulds (10⁴ CFU).

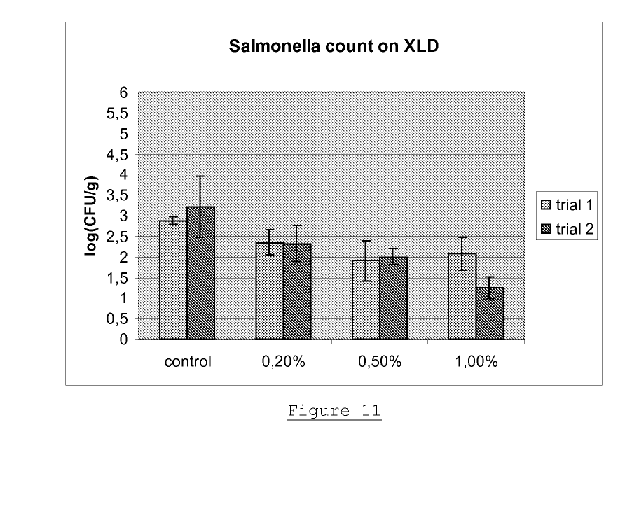

The results are shown on FIGS. 9 and 10. As can be seen, mustard oil encapsulated in micelles has an important inhibitory effect on the growth of yeasts and moulds.

### Example 4

A Salmonella cocktail comprising Salmonella senftenberg 775W #62, Salmonella typhimurium #52, Salmonella heidelberg #63, Salmonella enteritidis #53, Salmonella infantis # 54 was used to inoculate chicken samples.

To a marinade was added an emulsion according to the invention comprising oregano oil at different levels (see table below) in a ratio of 3:1 (marinade:emulsion).

The chicken samples were covered with the marinade and allowed to sit for 30 min. After 30 minutes, the Salmonella count was carried out and shown in FIG. 11

| 1% oil solution | 0.5% oil solution | 0.2% oil solution |
|---|---|---|
| 20% Admul T80K | 10% Admul T80K | 4% Admul T80K |
| 4% oregano oil | 2% oregano oil | 0.8% oregano oil |
| 76% distilled | 88% distilled | 95.2% distilled |
| water | water | water |

The results in FIG. 11 show that an emulsion comprising oregano oil encapsulated in micelles is able to inhibit Salmonella growth after 30 minutes only.

1. Food composition comprising nutritional ingredients and food-grade surfactant micelles incorporating at least one antimicrobial agent.

2. Food composition according to claim 1, which is selected from the group consisting of water, sauces, marinades, mayonnaises, mustards, ketchups, salad creams, salad dressings, soups, canned fruits, milk products, meats, fish, and vegetables.

3. Food composition according to claim 1, wherein the food composition has a fat content of not greater than 50%.

4. Food composition according to claim 1, which is free of additives.

5. Food composition according to claim 1, which has having a pH value between 2 and 8.

6. Food composition according to claim 1, wherein the nutritional ingredients are selected from the group consisting of carbohydrates, fats, proteins, fibres, minerals, vitamins, and mixtures thereof.

7. Food composition according to claim 1, wherein the food-grade surfactant is selected from the group consisting of the surfactant class of polyoxyethylene sorbitan monooleate, from animal sources, and plant sources that have active emulsifying properties.

8. Food composition according to claim 1, wherein the antimicrobial agent is selected from the group consisting of eugenol, limonene, and carvacrol.

9. Food composition according to claim 1, wherein the antimicrobial agent is selected from the group consisting of clove oil, bay oil, cinnamon oil, oregano oil, thyme oil, caraway oil, dill oil, coriander oil, citrus oil, orange oil, mustard oil and combinations thereof.

10. Food composition according to claim 1, wherein the antimicrobial agent is selected from the group consisting of clove oil, oregano oil, mustard oil and combinations thereof.

11. Food composition according to claim 1, wherein the antimicrobial agent is in a concentration of between 0.05% and 1.5% by weight of the food composition.

12. Food composition according to claim 1 which is shelf-stable at room temperatures.

13. Food composition according to claim 1, which is microbiologically safe against pathogenic bacteria, yeasts and moulds and stable with regard to microbiological spoilage.

14. Food composition according to claim 1, comprising no salt.

15. Food composition according to claim 1, wherein the water activity is greater than 0.5.

16. Method for improving the microbiological safety and stability of food comprising the steps of:
preparing an emulsion comprising food-grade surfactant micelles incorporating at least one antimicrobial agent, and
incorporating said emulsion into a food composition.

17. Method according to claim 16, wherein the emulsion is prepared by mixing a food-grade surfactant in an aqueous medium in order to form micelles, and then adding the antimicrobial agent to the micelle emulsion.

18. Method according to claim 17, wherein the concentration of antimicrobial agent in the aqueous medium is at least 0.1%.

19. Method according to claim 16, wherein the food-grade surfactant is selected from the group consisting of the surfactant class of polyoxyethylene sorbitan monooleate, from animal sources, and plant sources that have active emulsifying properties.

20. Method according to claim 16, wherein the emulsion is incorporated in the food composition in an amount of up to 80% by weight of the food composition.

21. Method according to claim 16, wherein the food composition is selected from the group consisting of water, sauces, marinades, mayonnaises, mustards, ketchups, salad creams, salad dressings, soups, canned fruits, milk products, meats, fish, and vegetables.

22. Method according to claim 16, wherein the antimicrobial agent is selected from the group consisting of clove oil, bay oil, cinnamon oil, oregano oil, thyme oil, caraway oil, dill oil, coriander oil, citrus oil, orange oil, mustard oil, and combinations thereof.

23. Method according to claim 16, wherein the antimicrobial agent is selected from the group consisting of clove oil, oregano oil, mustard oil and combinations thereof.

24. Use of an emulsion comprising food-grade surfactant micelles incorporating at least one antimicrobial agent in the manufacture, storage or preparation of a food composition.

25. Use according to claim 24, wherein the emulsion improves the microbiological safety and stability of said food composition.

26. Use according to claim 24, wherein the antimicrobial agent is selected from the group consisting of clove oil, bay oil, cinnamon oil, oregano oil, thyme oil, caraway oil, dill oil, coriander oil, citrus oil, orange oil, mustard oil and combinations thereof.

27. Use according to claim 24, wherein the antimicrobial agent is selected from the group consisting of clove oil, oregano oil, mustard oil and combinations thereof.

28. Use according to claim 24, for inhibiting the activity of bacteria, moulds, and yeasts.

29. Use according to claim 28, wherein the bacteria, moulds and yeasts are selected from the group consisting of Escherichia coli, Staphylococcus aureus, Bacillus cereus, Listeria monocytogenes, Lactobacillus buchneri, Salmonella enterica, Penicillium chrysogenum, Saccharomyces cerevisiae, Debaryomyces hansenii, Pichia farinosa, and Mucor plumbeus.

30. Use according to claim 24, wherein the antimicrobial agent is oregano oil and wherein the emulsion is used for completely inhibiting the activity of Salmonella spp.

31. Use according to claim 30, wherein the activity of Salmonella spp. is completely inhibited within five minutes of the emulsion coming into contact with said Salmonella spp.

32. Use according to claim 24, wherein the antimicrobial agent is mustard oil and wherein the food composition is one that is sensitive to mould contamination.

33. Method for improving the microbiological safety and stability of food comprising the step of
preparing an emulsion comprising food-grade surfactant micelle incorporating at least one antimicrobial agent in order to improve or reduce the sensory perception of said antimicrobial agent, and
incorporating said emulsion into a food composition.

34. Method according to claim 33, wherein the antimicrobial agent is selected from the group consisting of eugenol, limonene, and carvacrol.

35. Method according to claim 33, wherein the food is selected from the group consisting of water, sauces, marinades, mayonnaises, mustards, ketchups, salad creams, salad dressings, soups, canned fruits, milk products, meats, fish, and vegetables.

36. Dried antimicrobial product comprising a food-grade surfactant and an antimicrobial agent which, upon hydration, has the capability of generating an emulsion of micelles incorporating the antimicrobial agent.

37. Dried product according to claim 36 wherein the food-grade surfactant is selected from the group consisting of the surfactant class of polyoxyethylene sorbitan monooleate, animal source and plant sources that have active emulsifying properties.

38. Dried product according to claim 36, wherein the antimicrobial agent is selected from the group consisting of eugenol, limonene, and carvacrol.

39. Use of a product according to claim 36 in a dried food composition.

40. Use according to claim 39, wherein the dried food composition is selected from the group consisting of package soup, milk powders, and drink powders.
